(19) United States
(12) Patent Application Publication
(10) Pub. No.: US 2015/0127531 A1
(43) Pub. Date: May 7, 2015

(54) REAL TIME RECURRING DISTRIBUTOR BILLING FOR SUBSCRIPTION PRODUCTS

(71) Applicant: PAX8, INC., Lone Tree, CO (US)

(72) Inventors: Klaus J. Dimmler, Colorado Springs, CO (US); Michael Carl Driscoll, JR., Parker, CO (US); Ryan Walsh, Highlands Ranch, CO (US)

(73) Assignee: PAX8, INC., Lone Tree, CO (US)

(21) Appl. No.: 14/179,415

(22) Filed: Feb. 12, 2014

Related U.S. Application Data
(60) Provisional application No. 61/900,857, filed on Nov. 6, 2013.

(51) Int. Cl. G06Q 20/14

(52) U.S. Cl. CPC G06Q 20/14
USPC 705/40

(57) ABSTRACT

A system of billing for subscription products and services from multiple vendors across multiple layers of buyers and sellers is presented. Each subscription is charged according to a rate plan, which may include volume, tiered, or usage-based pricing. In billing for subscriptions, sellers may use a single standard rate plan for each product, or may use a variety of rate plans depending on the type of customer, time period, or other attributes. The rate plans stored in the system are dynamic, such that a seller can instantly modify an existing rate plan in order to create a new rate plan.

### RELATED APPLICATION

The present application is related to and claims priority of U.S. provisional patent application (“Provisional Patent Application”), Ser. No. 61/900,857, filed on Nov. 6, 2013. The disclosure of the Provisional Patent Application is hereby incorporated by reference in its entirety.

### FIELD OF INVENTION

According to an embodiment of the present invention, the present system and method addresses subscription management and billing in cloud computing environments comprising sales and distribution channels involving multiple buyers and sellers. In particular, the invention presents a system and method for a distributor to manage and bill for cloud services sold to end customers through resellers, as well as a system and method for a distributor to provide billing and management capabilities to those resellers.

### BACKGROUND

IT solution providers, managed service providers, value added resellers, and IT consultants, collectively referred to herein as “resellers,” are in the business of selling, managing and administering a customer's server and workstation computer systems, the networks that connect them, and the application software that runs on them. The emergence of cloud computing has caused a shift from computer hardware and software installed on that hardware to subscription-based cloud computing services. This shift has created new challenges for resellers, particularly in the area of invoicing and billing.

Providing a complete cloud computing solution generally involves provisioning many cloud services from different vendors for each customer. Each cloud service is purchased by a reseller from a vendor, and is then resold to a customer. Volume selling justifies a lower price from the vendor, which enables the reseller to make a profit on the subscription service.

At the end of each month, or some other interval, the reseller is invoiced by each vendor from which the reseller has purchased services on behalf of customers. The reseller must then create an invoice for each customer. Reconciling the total amount charged by each vendor and individually invoicing customers becomes a significant challenge, especially as the reseller's customer base grows. Calculating profitability on a per customer basis is equally problematic.

A reseller sometimes purchases cloud services directly from the vendor and resells those service to customers, as discussed above. In other instances, however, a Reseller A aggregates many cloud services and sells them to other resellers, thereby providing those resellers the benefit of “one stop shopping.” In this case, Reseller A is known in the industry as a “distributor,” or a “value-added distributor” (VAD). When a distributor sells a product or service to a Reseller B, which in turn sells it to Reseller C, Reseller C is known as a “downstream reseller.” Reseller C then sells to a customer, or to another downstream reseller, which then sells it to a customer.

There is thus a cloud services supply chain consisting of a series of buyer/seller transactions, wherein the seller acquires the product in a first transaction, then sells it to a buyer at a higher price. An example sequence of buyer/seller transactions is: (1) Distributor (buyer at price A)/vendor (seller), (2) Reseller A (buyer at price B)/Distributor (seller), (3) Reseller B (buyer at price C)/Reseller A (seller), and (4) End customer (buyer at price D)/Reseller B (seller).

Each seller in this supply chain bills its buyer, and makes a profit that is determined by the price difference between the price at which the seller acquired the product and the price at which that seller sells it to its customer. So, in the example above, (1) Vendor invoices Distributor at price A, and makes a profit A multiplied by the number of products minus the vendor's cost of providing that service, (2) Distributor invoices Reseller A at price B, and make a profit on each product of price A minus price B, and (3) Reseller B invoices End Customer at price C, and makes a profit on each product sold of price B minus price C. Management of the financials associated with these sales across the entire supply chain, such as the generation of invoices, tracking payments, and account profitability, can be very difficult to manage.

It should be noted that in some business arrangements the reseller does not invoice the buyer directly. Instead, an upstream reseller invoices the buyer of a product on behalf of the downstream reseller who sold the product to that buyer. For instance, in the example above, Distributor could invoice End Customer on behalf of Reseller B, invoice Reseller A on behalf of Reseller B, and then pay to each reseller in the chain the profit they would have made if they had invoiced their buyer directly. In this example, for each product, Distributor would pay Reseller A an amount equal to price A minus price B, and Reseller B an amount equal to price B minus price C. Each reseller makes the same profit in this arrangement, but the distributor manages cloud subscriptions on behalf of its downstream resellers and handles billing and invoices. The distributor often charges an additional management fee for this service.

In order to close a particularly beneficial sale, a reseller may want to reduce the price of a particular cloud service for a particular buyer. In this case, the profit margin per product is reduced, but might be compensated by some other benefit such as high sales volume of that product or a lucrative sale of another product. This situation can occur anywhere in the supply chain. Making immediate sales commitments with altered product pricing is often difficult because calculations need to be made in order to assure sufficient profitability. Moreover, managing multiple exceptions significantly increases the complexity of financial management.

Given these challenges, it would be desirable to provide a billing system that manages and tracks cloud services subscriptions across the entire supply chain, permits any seller in the supply chain to instantaneously change pricing for any single order during the order or quoting process, and calculates profitability on a per customer basis in real time for use during the negotiation process. Entities in the supply chain would also benefit from a billing system that generates unified and itemized charge information, and allows resellers to elect from different billing options, such as invoicing or automatically charging customers through the billing system, or receiving aggregated charge monthly charge information for all customers.

In addition, entities in the supply chain would benefit from a system for tracking, studying, and responding to customer buying habits and price sensitivity. For a distributor, an ideal tool would track and analyze sales associated both with the distributor's direct-relationship resellers and with end customers. This information would enable a distributor to be responsive to the entire supply chain in terms of product offerings, subscription plans and pricing, and discounts.

The prior art includes various subscription management and billing systems. It includes, for example, a subscription billing system that accommodates multiple rate plans, permits a quote to be converted into an order that creates a subscription, includes a billing engine, and allows for hierarchical customer accounts. (US Application Pub. No. 2014/0012706—Foerster—Methods and Systems for Processing Orders in a Subscription Based Billing System). It includes various cloud services marketplaces and management platforms designed for a multi-tiered supply chain and a subscription-based delivery model. Many of these platforms include billing capabilities and/or integrate with other billing programs. These include the services provided by AppDirect, Nuvotera, Jamcracker, and ArrowSphere. The prior art also includes a method for improved billing and ordering for phone and Internet services that involves storing rate plan information and includes some dynamic features, such as usage and order entry (WO Publication No. 2012/135163, Published Oct. 4, 2012, —Netcracker Technology Corp—Systems and Methods for Improved Billing and Ordering).

The prior art describes a dynamic pricing method that applies multiple pricing states to a particular product, defines one or more triggers that enable the pricing to transition from one pricing state to another, and associates each pricing state with a pricing mechanism (such as auction, sale, rental, or subscription). The pricing program can be implemented immediately or stored for implementation at a later time (U.S. Pat. No. 8,533,058 B1, Issued Sep. 10, 2013, Agarwal et al., Method and Computer-Readable Medium for Automated Dynamic Pricing of Products with Parameter-Driven State Transitions).

Apparently missing from existing systems and services, however, is the combination of several key billing capabilities designed for a complex subscription-based distribution channel: the ability for a seller to simultaneously employ multiple active rate tables that apply to different product-buyer combinations, instantly generate a new pricing structure (rate table), to see the effect of the new rate table on profit margins, apply the new rate table to a particular buyer or set of buyers, and use it to instantly generate a quote or order.

Thus, there remains a need for a single billing system that can be used by entities on multiple tiers of the supply chain to manage subscriptions, instantly create new rate tables to meet specific margin requirements or to accommodate specific customers, use those rate tables to instantly generate quotes, and convert those quotes to orders.

### SUMMARY

Embodiments of the present invention describe a system and method for managing, billing, and analyzing transactions involving cloud products and services from multiple vendors across a multi-tiered supply chain. The supply chain generally consists of a distributor, which sells products and services from multiple vendors to multiple resellers, who in turn supply numerous end customers.

In at least some embodiments, the distributor negotiates terms and rates with the vendors, which are stored in the system. The distributor may then establish pricing for its resellers, which is also stored in the billing system. The billing system stores pricing information in the form of rate tables, and accommodates multiple rate tables for each product and each seller. The system is further configured to allow sellers using the system to instantaneously generate new rate tables and use them to generate quotes, which can then be converted to orders.

Cloud services are often purchased as annual or monthly subscriptions. Each subscription is charged according to a rate table, which may include volume, tiered, or usage-based pricing. The billing system is configured to store multiple subscriptions for each buyer, and may also be configured to accommodate one-time charges. The system is further configured to aggregate subscription and other charges on a periodic basis, such as monthly, and to generate account statements or invoices, which can be made accessible or presented to resellers and/or end users.

The system also stores the supply chain hierarchy and includes control features so that, at each level, the “parent” entity has control over the billing system features and privileges available to its “child” entities.

The billing system also makes available to each seller in the hierarchy information about all of its customer accounts, recurring and one-time transactions, and its profit margins for each product and each customer. The system may also be configured to provide additional financial and market analytics.

### BRIEF DESCRIPTION OF THE DRAWINGS

FIG. 1 is a diagram depicting an example supply chain.

FIG. 2 is a diagram depicting an example computing environment.

FIG. 3 is a diagram depicting key components of the billing system.

FIG. 4 is an example distributor price list.

FIG. 5 depicts example rate tables.

FIG. 6 is a diagram depicting how orders placed in the system generate subscriptions and one-time transactions by accessing the account database and the appropriate rate tables.

FIG. 7 is a diagram depicting the system's generation of a charge line item for a specific company, product, and billing period, by accessing the account database and appropriate rate table.

FIG. 8 is a diagram depicting the billing engine's use of charge line items to generate an invoice for a particular company.

FIG. 9 is a flow chart depicting at least some of the billing features and options of the system.

FIG. 10 is a flow chart depicting at least some of the hierarchical control features of the system.

### DETAILED DESCRIPTION OF PREFERRED EMBODIMENTS

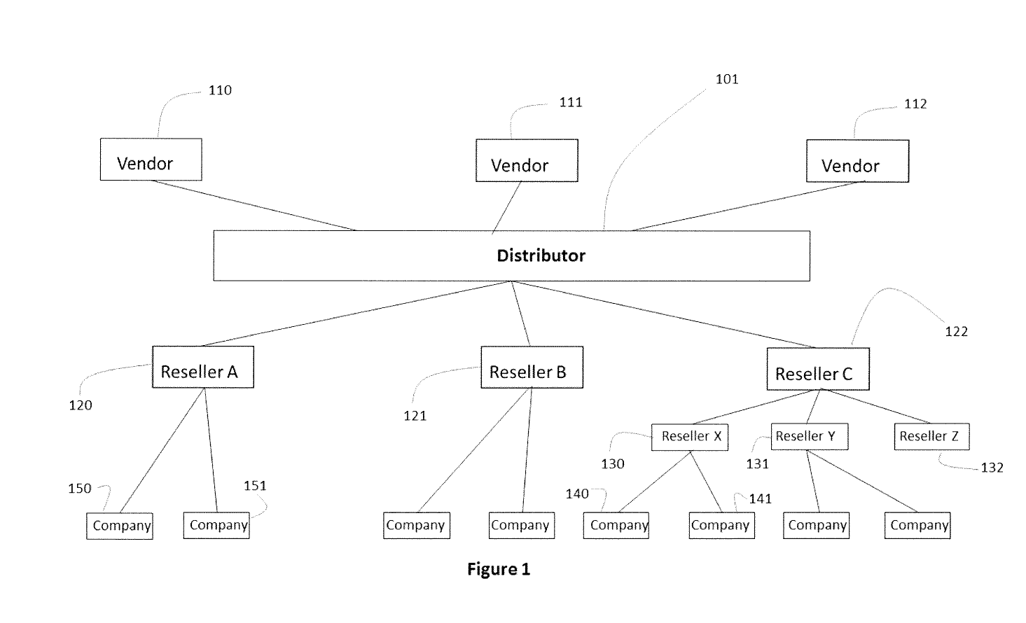

Referring to FIG. 1, a supply chain that delivers cloud services from the vendor to end customers (“companies”) is outlined. In some instances (not shown), a reseller purchases cloud services directly from the vendor and sells those services to companies. In other instances, however, a distributor 101 aggregates many cloud services from multiple vendors 110, 111, and 112, for sale to resellers 120, 121, and 122. In some instances, a distributor 101 may sell cloud services to a reseller 122, which in turn sells to other resellers 130, 131, and 132. In this example, reseller 122 is known as an “upstream reseller,” and resellers 130, 131, and 132 are known as “downstream resellers” of reseller 122. These downstream resellers, in turn, sell the service to yet another entity. For example, Reseller 130 may then sell the cloud services to companies 140 and 141. In some cases, the upstream reseller 122 is a “master agent,” and downstream resellers 130, 131, 132 are known as “subagents.” This nomenclature often applies where the master agent recruits the subagents for the distributor, the distributor sells to the subagents, and the master agent receives a commission for the subagents' sales to companies or other reseller. In some instances, the supply chain involves only a single reseller, as for example reseller 120 selling to companies 150 and 151.

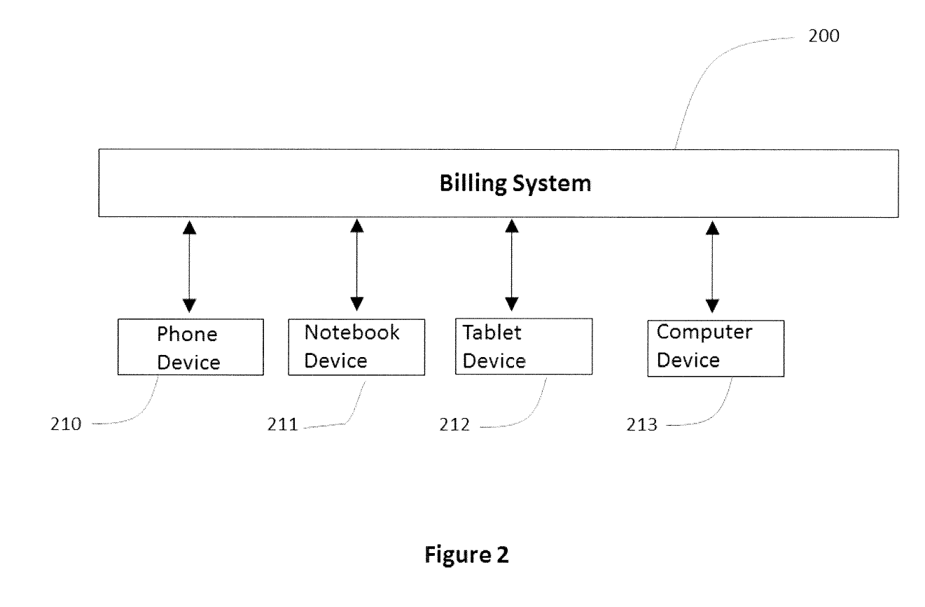

FIG. 2 depicts aspects of a computing environment in accordance with at least one embodiment of the invention. Billing system 200 accepts connections from multiple client computer devices of a variety of types, including phone device 210, notebook device 211, tablet device 212, and computer device 213.

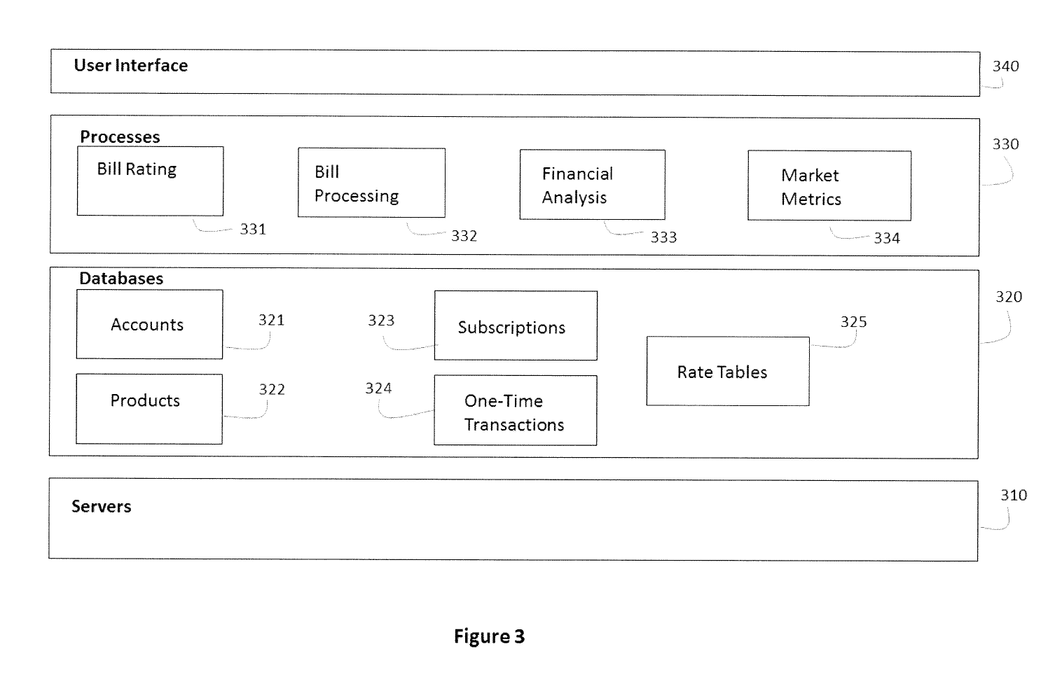

The internal structure of the billing system is displayed in FIG. 3. The system runs on computer hardware consisting of servers 310, which run a database set 320 and a process set 330. User interaction with the system occurs through a User Interface 340. The database set 320 consists of databases Accounts 321, Products 322, Subscriptions 323, One-time transactions 324, and Rate Tables 325. Processes 330 that operate on these databases include Bill Rating 331, Bill Processing 332, Financial Analysis 333, and Market Metrics 334.

The Accounts database 321 of FIG. 3 stores information about system users. For each user, it stores information such as entity name and user names and passwords for individual users and administrators. It stores address, billing, and credit card information. It also stores information about the account's relationship to other users or accounts in the system. For example, a downstream reseller account is associated with an upstream reseller's account, as well as the accounts of the companies to which it sells.

The Products database 322 of FIG. 3 stores a comprehensive listing and specifications of all products available in the system for purchase and sale.

The Subscriptions database 323 stores and tracks information about all of the subscriptions that exist in the system. It tracks the number of subscriptions for each product, the number of subscriptions for each product for each user, and the number of units cumulatively purchased by each user. All one-time transactions are contained in the One-Time Transactions database 324.

The Rate Tables database 325 stores the price of each product for each reseller under various conditions such as volume of products purchased and discounts.

The Bill Rating process 331 of FIG. 3 periodically (daily or monthly) utilizes data in the database set 320 to create one transactional item (price) for each product-buyer combination for each rating period.

The Bill Processing component 332 is configured to compile, at the close of the billing period, the transactional items generated by the bill rating process 331. The bill processing component compiles the items into the appropriate format, as determined by each buyer (reseller or company) and/or its seller (distributor or reseller). The functions of the bill processing component may include storing merchant account information and credit card information. It may include preferences such as whether the system sends aggregate charge information in spreadsheet form to the seller, or sends an invoice directly to the buyer. In some embodiments, it also allows an upstream seller to bill on behalf of a downstream seller.

The financial analysis 333 and market metrics 334 processes draw information from all parts of the system to provide real-time financial and market analysis. Results can be summarized and displayed on the screen during the order and quoting process, and used to evaluate if/then scenarios before an entity commits to a new price. Financial analysis may include profit margin calculations, discounts from previous prices, average price and profit margin across a seller's customer base for a given product, and the average margin across all sellers on a particular tier of the supply chain or throughout the supply chain.

In addition, the data structure can support real-time market analysis across the entire supply chain, including: 1) volume of products sold by a seller versus the per-unit price of a given product; 2) characteristics of companies (size, revenue, etc.) versus product usage & profitability; 3) performance characteristics of the product for any given customer versus price paid.

In some embodiments, the financial analysis engine may be configured to communicate with external databases to provide an even more robust market analysis.

The system also includes at least one user interface 340 that permits users, depending on the system configurations, user type, and level of access, to order, quote, bill, and establish account and billing preferences.

In a usual cloud services supply chain, a distributor negotiates wholesale rates with multiple vendors, then establishes default reseller pricing and suggested retail pricing for each product. In addition, the distributor can generate different pricing for a particular reseller or group of resellers, and resellers can establish different pricing for a particular company or group of companies. The billing system therefore accounts for and distinguishes between at least the following different types of prices:
Reseller price: the price from the distributor to the reseller, where pricing is determined by the distributor, and can vary from reseller-to-reseller.
Suggested retail price: the retail price suggested by the distributor and presented to the reseller to be used as the default retail price to the company.
Actual retail price: the actual price from the reseller to the company. This price is set by the reseller, and can vary from reseller-to-reseller and from company-to-company.
In some instances, commissions are used to remunerate at least one member of the supply chain. In such cases, the system will also be configured to use:
Commissions: a system of payment based on a percentage of the value of sales. Commission information will be stored in a rate table as an amount that represents the appropriate percentage of the sales. For example, a distributor may structure its supply chain so that the distributor sells to the downstream reseller (subagent), and the upstream reseller (master agent) receives a percentage of the distributor's sales to the subagent, or of the subagent's sales to companies. Alternatively, the distributor's relationship with the vendor may be commission-based, so that the distributor receives a commission based on the reseller's sales to companies.

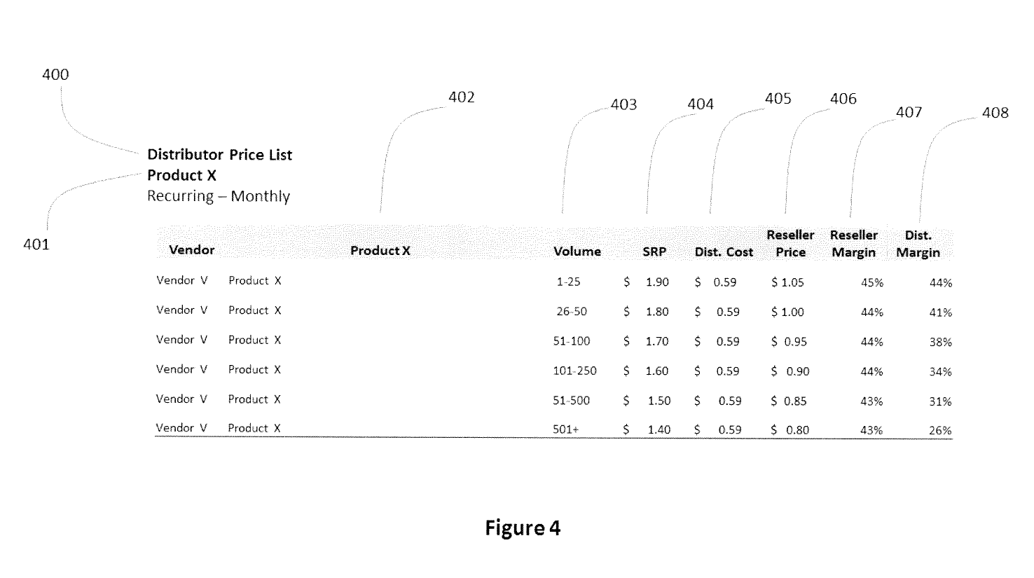

FIG. 4 depicts a sample price list established by a distributor 400 for a particular Product X 401, 402. In the example shown, the pricing for Product X is volume-based, with discounted pricing for higher volume tiers 403. The Distributor Cost column 405 shows the distributor's price from the vendor. The Reseller Price column 406 shows the distributor's default price to resellers. The distributor may change this pricing for any particular reseller or group of resellers. The SRP column 404 shows the distributor's suggested retail price for Product X. The reseller may change this pricing for all or a subset of its companies, or for a particular company. The Distributor Margin column 408 shows the distributor's profit margin if the default reseller price is used. The Reseller Margin column 407 shows the reseller's profit margin if the Reseller Price 406 and the distributor's suggested retail prices 404 are used.

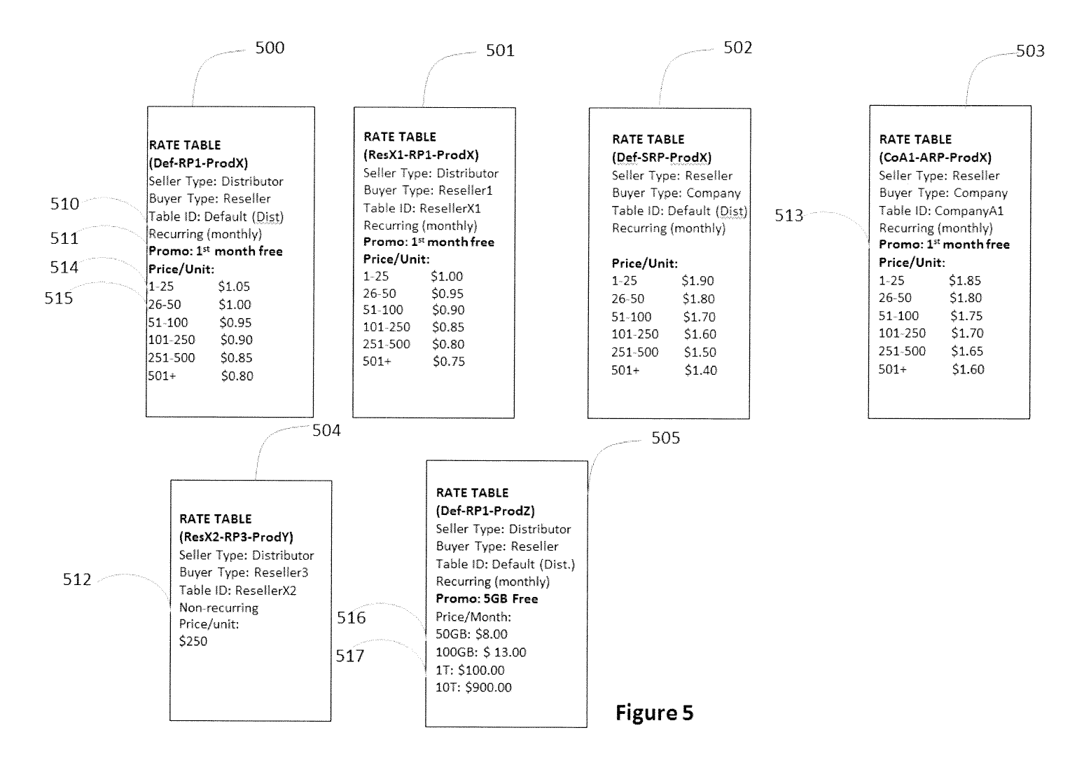

While FIG. 4 shows default pricing between multiple entities in the supply chain, as might be used by a distributor to track its own pricing and margins, the billing system uses and stores pricing information in the form of rate tables. The billing system handles at least the following types of rate tables, examples of which are shown in FIG. 5:
Reseller Price (RP) Tables: A default reseller price rate table 500 is established by the distributor for each product SKU. The distributor may establish one default RP rate table for all resellers, or may establish different default RP rate tables for different groupings of resellers. For example, default rate table 500 applies to Type 1 resellers. Thus, the rate table is identified as the Default (Def) pricing for Type 1 resellers (RP1) for Product X (ProdX) 500. The default RP table will then be used as the pricing for the relevant set of resellers unless overridden. If the distributor changes the pricing for a particular reseller, Reseller X-1, a new rate table 501 is created.
SRP Tables: A default SRP table is established by the distributor for each product, which will be used as the default pricing for all companies unless overridden. Thus, the distributor establishes default suggested retail pricing for Product X 502, identified as Default (Def)-Suggested Retail Pricing (SRP)-for Product X (ProdX).

ARP Tables: A reseller may override the SRP default values for any given company, resulting in a new actual retail pricing (ARP) table. For example, if a reseller alters the distributor's default SRP for Company A1, a new rate table: CompanyA1 (CoA1), Actual Retail Price (ARP) for Product X (ProdX) 503 is created. A reseller may alter the pricing for Company A again, thus generating a new rate table for Company A, or it may alter the suggested retail pricing for another company or group of companies. The reseller may also create its own default retail pricing, which it may then apply to all companies unless altered for a specific company or subset of companies.

Pricing for any particular entity may be updated any number of times, each time creating a new table which becomes the active table. Though inactive, older tables are kept in the rate table database for billing, reporting, and analysis purposes.

A rate table contains all pricing information for a particular product as between one seller or set of sellers and one buyer or set of buyers. This includes whether the price is recurring (generally monthly) 510 or non-recurring 512. The system is configured so that prices are recurring by default. If the non-recurring option is checked, the product has a one-time price.

A rate table also includes any special pricing information and applicable discounts or promotions. For example, the distributor may offer a first free month of a subscription service 511 as part of the default reseller pricing 500, but it may decide not to pass this on to companies as part of its suggested retail pricing 502. A reseller, however, may elect to pass on the first free month promotion to a particular company, Company A-1 513.

In addition, any volume discounts are reflected in the rate table for a given product. A volume discount reduces the price for one unit of a product by a given percentage for each non-overlapping range of units. For example, the per unit price for a given product may be $1.05 per unit if up to 25 units are purchased 514, but $1.00 per unit if 26-50 units are purchased 515.

A tiered pricing structure may also be used. Volume pricing is the default, but tiered pricing may be applied if specified by the entity establishing the pricing. With tiered pricing, prices for multiple volume tiers may apply to a single transaction. For example, for a Product X for which the rate table establishes volume tiers, with 1-50 units as the first tier and 51-100 units as the second tier, tiered pricing would mean that a buyer of 75 units pays the first tier price for the first 50 units, and the second tier price for the next 25 units. In addition to per license or “per seat” pricing, pricing may be based on capacity, such as per gigabyte 516 or terabyte 517. Pricing may also be based on the customer's actual usage of a resource, such as bandwidth or virtual storage space.

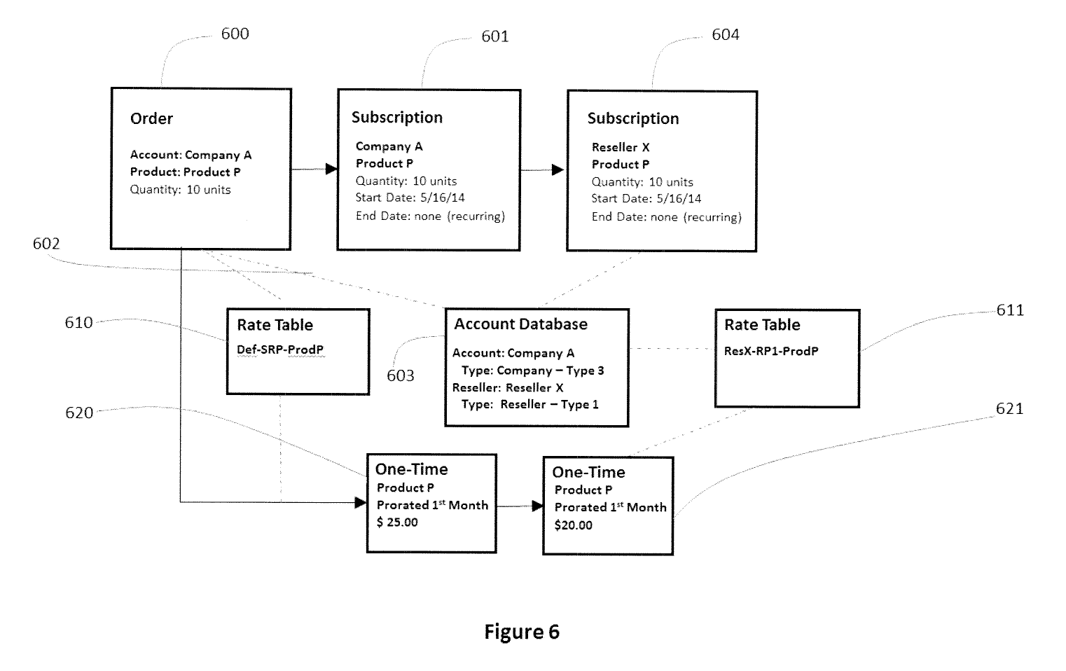

When an order is placed for a particular product, the billing system uses stored information to create at least one subscription (recurring charge) and/or at least one non-recurring charge. In the example depicted in FIG. 6, Company A places an order for ten units of Product P 600. A subscription 601 is generated from the order. The subscription information stored in the subscription database includes the entity name, product name, quantity, the subscription start date, and, optionally, the subscription end date.

When the order is placed, the system accesses the account information for the entity placing the order to determine which other entities in the supply chain are involved in the transaction 602. In the example depicted in FIG. 6, the Account Database indicates that Company A is associated with “upstream” entity Reseller X 603. It also indicates the entity type for both Company A and Reseller X 603. The entity type designations determine the relationship between entities. For example, in one relationship type, indicated in FIG. 6 by “Reseller—Type 1,” the distributor sells products and services to the reseller, which sells to companies. Another possible arrangement includes two tiers of resellers, a master agent and a subagent. In such a scenario, the account database would indicate this arrangement through the entity type.

In the example depicted in FIG. 6, an order placed by Company A creates two subscriptions for Product P: one for Company A's purchase from Reseller X 601, and another for Reseller X's purchase from Distributor 604. Because there may be one-time charges associated with a subscription service, the system also accesses the appropriate rate tables for Product P 610, 611 to determine if any non-recurring charges should be generated as a result of the order. Examples of such one-time charges may include a prorated first month or an installation fee. The system accesses the appropriate rate plan by first searching for any specific rate plan that has been created for that specific entity. In FIG. 6, for the rate table applicable to Company A, the system would first search for CoA-ARP-ProdP. Finding no specific rate table for Company A, the system searches for suggested retail pricing for Company —Type 3: Def-SRP3-ProdP. Finding no suggested retail pricing specifically for Type 3 companies, the system uses the default suggested retail pricing for all companies: Def-SRP-ProdP 610. The system repeats this process to determine the applicable rate table for the Reseller X's purchase from the Distributor. It first searches for a rate table created specifically for Reseller X. In this case there is such a rate table: ResX-RP1-ProdP 611.

Having determined the appropriate rate tables 610, 611, the system queries whether there is a non-recurring cost associated with Company A's order for Product P. In the example in FIG. 6, there is such a cost—a prorated first month—so a one-time transaction 620 is created in the one-time transactions database. Similarly, a one-time transaction is created for the corresponding Distributor-Reseller X transaction 621 that results from the order 600.

In other instances, an order would consist only of a product or service with nonrecurring pricing. Similarly in that instance, a nonrecurring charge would be created in the one-time transactions database.

The system uses a bill rating process to tally these recurring and one-time transactions for billing and reporting purposes. In the preferred embodiment, the bill rating process is used both to tally transactions on a real-time or nearly real-time basis for informational and reporting purposes, and to generate billing statements and invoices on a less frequent basis such as monthly.

During a rating event, the billing system identifies the appropriate data components from the subscription database and the one-time transactions database and uses them to create charge line items. Assuming daily rating has been chosen, at the end of every day, a single charge line item is generated for each product-buyer combination. Thus, a line item is created for each Product X and each Reseller W that is paying the default RP for a given quantity Q, the price of which is determined as follows:

Q(ProdX,ResW)*(Def-RP-ProdX)*[1/(days in the month)]

If the price for a particular Reseller Y was changed, then the table specific to that reseller would apply. In this case, the price is determined as follows:

Q(ProdX,ResY)*(ResY1-RP-ProdX)*[1/(days in the month)]

Similarly, for any given Company X that is paying SRP, a transaction for each product is sent to the billing engine, the price determined as follows:

Q(ProdX,CoX)*(SRP-ProdX)*[1/(days in the month)]

If the Reseller changes the pricing for any Company A, then the price of the transaction for a given product X that is sent to the billing engine is determined as follows:

Q(ProdX,CoA)*(CoA-ASP-ProdX)*[1/(days in the month)]

If the rate table for an entity with an existing subscription is changed, the entity making the change may specify the effective date of the new rate table. A new rate table will generally take effect at the beginning of a new billing period. If no effective date is specified, the change will take effect during the next rating event. Therefore, if daily rating is chosen, the rate change will take effect with the next daily rating event unless another effective date is specified.

These line item data can be used for a variety of informational and reporting purposes performed by the financial analysis 333 and market metrics 344 processes. For example, the billing system may be configured to display to the distributor a daily tally of its recurring revenue and nonrecurring revenue. It may also be used to display to the distributor or a reseller the revenue associated with a particular company or a particular product, or the number of subscriptions for a given product.

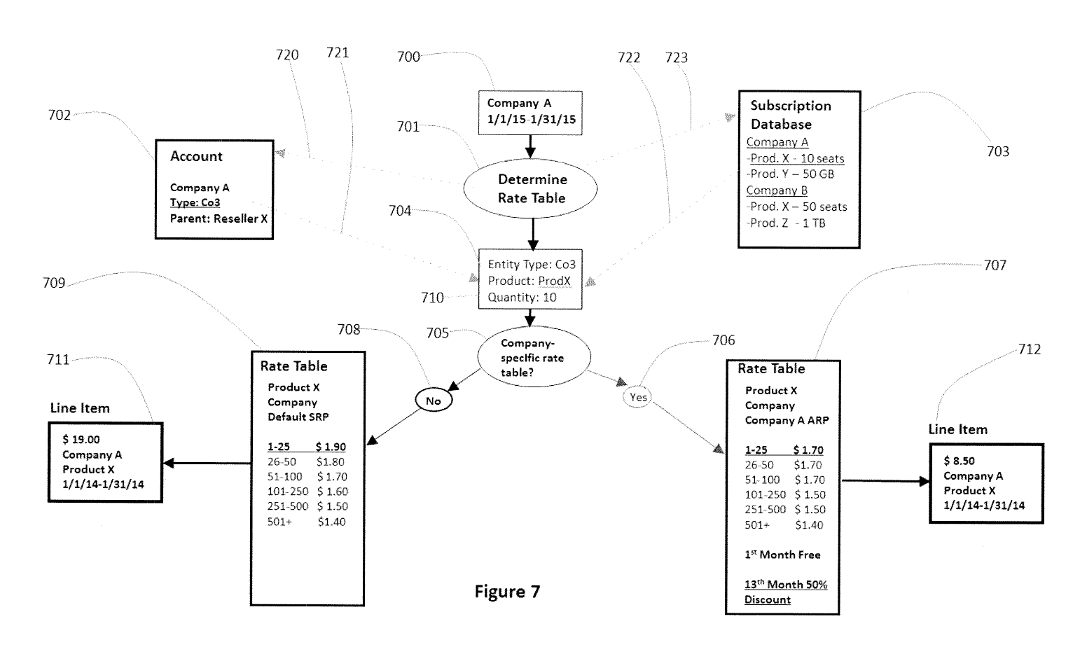

Assuming a monthly billing cycle, bill rating can also be conducted monthly to generate charge line items for billing purposes. FIG. 7 depicts an example monthly bill rating process in which the system generates charge line items for Company A for the billing period 1/1/15 to 1/31/15 700. In order to determine the appropriate rate table 701, the system queries 720 the account database 702 to determine the entity type (Company—Type 3 (Co3)), and queries 723 the subscription database 703 to determine the products for which Company A has an active subscription. The queries having returned the requested information 721, 722, 704, the system first searches for a specific rate table for Company A 705. If such a rate table has been created 706, the system uses that rate table 707 to generate the charge line item 712. The system incorporates all relevant information from the rate table to generate the charge line item. For instance, in 707, the rate table includes a discount for the 13^{th} month of the service, which is reflected in the charge line item 712. (The example assumes that January 2015 is Company A's 13^{th} month of the service.)

If no Company A-specific rate table exists 708, the rate table for the default suggested retail price 709 is used. Using the quantity information 710 and the rate table 709, a charge line item 711 is generated.

This process is repeated for Company A for every product for which Company A has a subscription, then for each of Company A's one-time transactions during the relevant billing period.

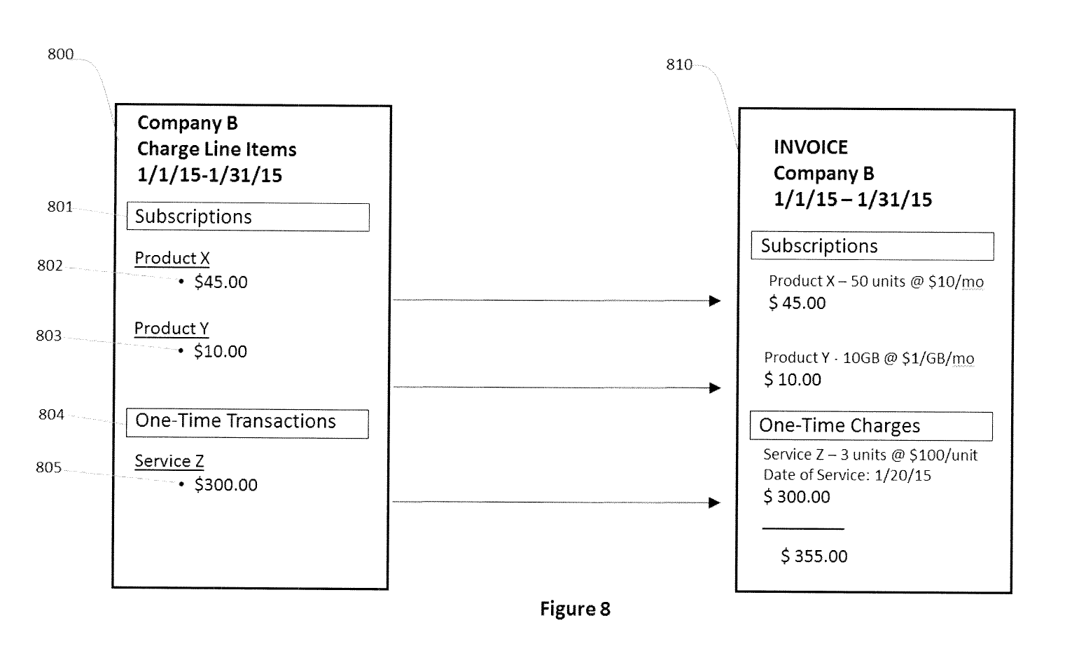

The individual charge line items can be combined in a number of ways for billing purposes, depending on the system configurations and the preferences of the relevant entities. For example, the line items may simply be used to generate an invoice for a particular company. The distributor may offer its resellers a “bill on behalf” option, where the distributor, through the billing system, bills the company on behalf of the reseller. FIG. 8 is example of an invoice that may be generated if this option is selected by the reseller. The billing engine identifies the charge line items for Company B for the billing period 1/1/15-1/31/15 800, including the recurring (subscription) charges 801: $45.00 for Product X 802, and $10.00 for Product Y 803; and the one-time transactions 804 during the billing period: $300.00 for Service Z 805. The bill processing engine uses these charge line items to generate an invoice 810 for Company B.

In another billing arrangement (not shown), the reseller may elect to receive a compilation of all its companies' charge line items at the close of every billing period, usually in spreadsheet form. The reseller may then use this information to prepare its own billing statements or invoices.

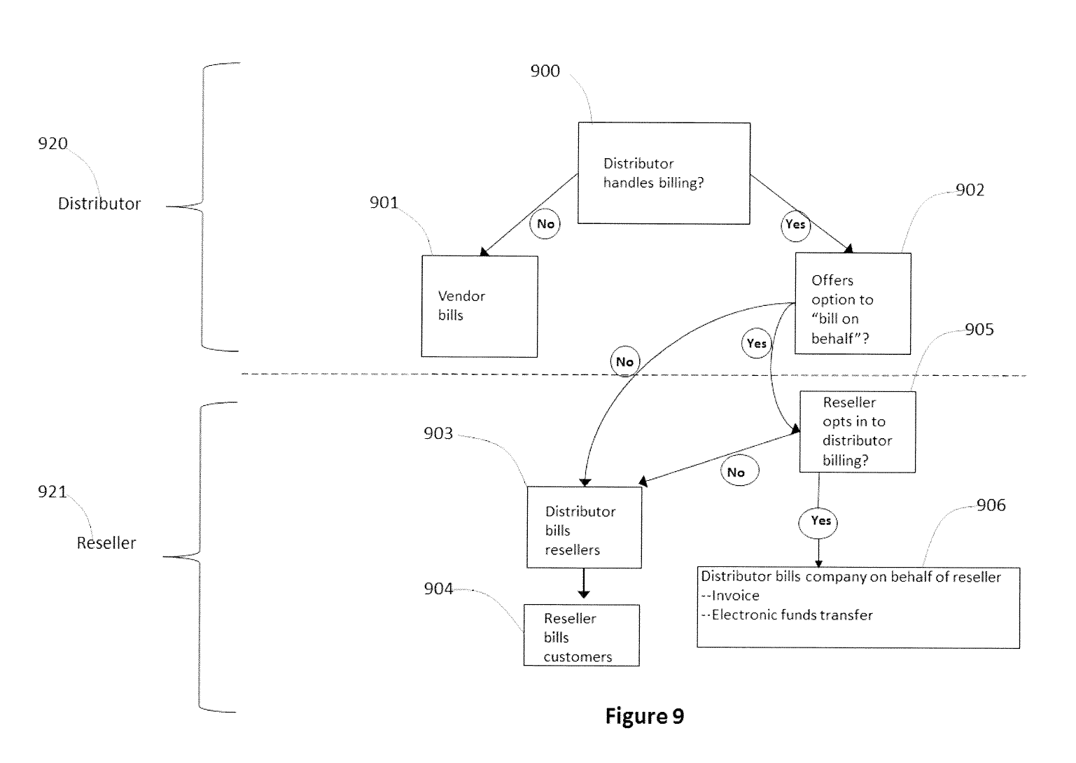

Several additional options and variables are associated with the bill processing component of the system. FIG. 9 depicts some example features available to a distributor 920 (shown above the dotted line) and a reseller 921 (shown below the dotted line).

One variable is whether a distributor handles billing 900. A distributor may handle billing for, some, all, or none of the transactions managed through the billing system. For at least some products, the distributor may not handle any billing; the vendor would then bill resellers and/or companies 901. If the distributor does handle billing for a given product 902, it may bill resellers only 903, or it may offer a “bill on behalf” service 905, whereby it will bill a reseller's company on behalf of a reseller, if the reseller so chooses. The distributor may charge a fee for this service. If the distributor does not offer this option, or the reseller chooses not to use this service, the reseller bills its own companies 904.

If the reseller chooses to use the distributor's “bill on behalf” service, the distributor bills the company on the reseller's behalf 906. This may take the form of an invoice generated through the system, or an automatic charge through an electronic funds transfer.

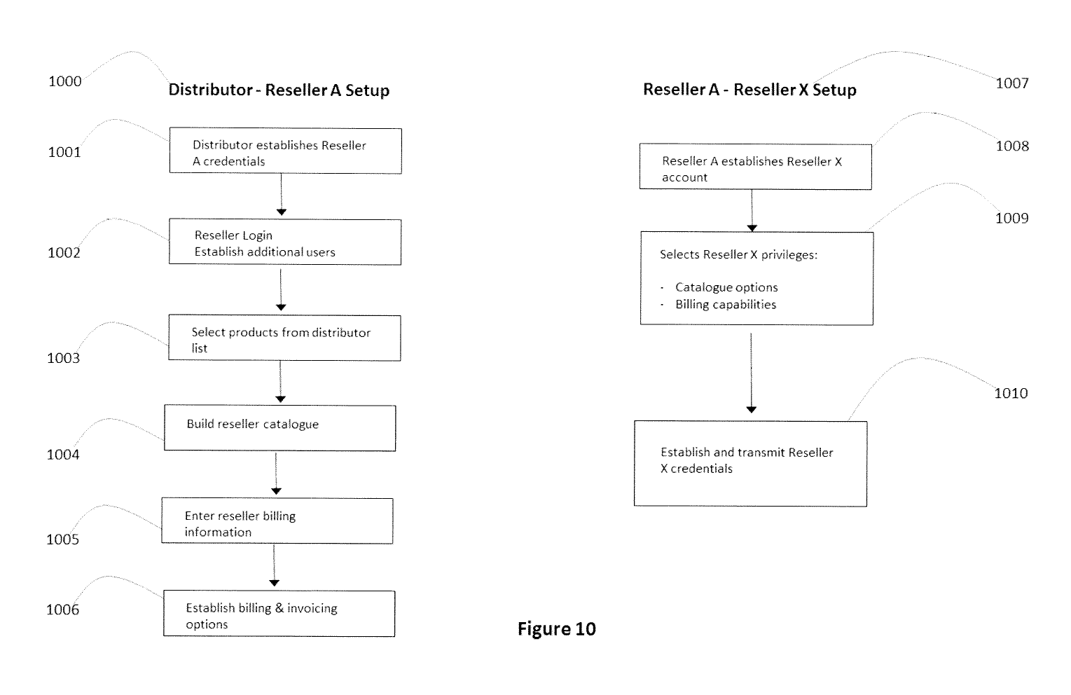

The billing system is configured with hierarchical controls so that the upstream entity controls the features and options available to the downstream entity. FIG. 10 shows an example account setup for Reseller A 1000, where Reseller A is an upstream reseller given access to the system by the distributor. The distributor establishes Reseller A's account and sets the credentials for an administrator designated by Reseller A 1001. The administrator for Reseller A may then log into the system and establish any additional users 1002. The administrator may determine the level of access for each user type. For example, sales users may be given the ability to generate quotes and place orders, thus having access to Reseller A-to-buyer pricing information, but not be given access to information about Reseller A's buy rate from the vendor or distributor. The administrator may choose to restrict other users to view-only access.

The user interface for Reseller A includes a list of products established by the Distributor to which the Reseller has access. Reseller A selects from this list the products it wishes to sell 1003. Reseller A may also add additional products (and associated specifications and pricing) that it wishes to sell but acquires from a source other than the Distributor 1004 (products not already set up in the system). Depending on the arrangement, Reseller A may also enter its billing information as part of the set-up process 1005.

In at least some embodiments, Reseller A may also configure certain billing and invoicing features of the system which will apply to Reseller A's transactions with downstream resellers and/or companies 1006. For example, Reseller A may elect to have Distributor (through the system) bill on Reseller A's behalf. Distributor has configured the system to allow Reseller A this option. If Reseller A elects to use this feature, Distributor will transmit invoices (brand-able by Reseller A), to Reseller A's downstream resellers and/or end customers.

In some instances, Reseller A acquires products and services from the Distributor, and resells them to a downstream reseller, Reseller X, which in turn sells them to companies. In this situation, Reseller A may give Reseller X access to the system and exercises full control over the features available to Reseller X 1007. An administrator for Reseller A logs into the system and enters basic account information for Reseller X, including the identity of the Reseller X administrator 1008. The Reseller A administrator establishes the privileges and features that will be associated with Reseller X's account. For example, Reseller A establishes which products and services Reseller X may sell (by selecting which products will appear in the product catalogue in Reseller X's user interface) 1009. Reseller A also controls Reseller X's access to any billing options made available to Reseller X by the distributor or vendor 1009. In some embodiments, a distributor may provide a billing service, such that the distributor (through the billing system), bills a reseller's customers on behalf of the reseller. If the distributor has made this service available to Reseller A, Reseller A has control over whether it is available to Reseller X as part of the process of establishing Reseller X's account in the system. Finally, the Reseller X administrator is given the credentials for the new account 1010.

Reseller X, in turn, may decide whether to give its companies' end users access to the system and, if it does, what features are available to those users. For instance, Reseller X may want customers to have access to the system in order to place orders, but may configure the system to require Reseller X's approval before an order is finalized. Reseller X may also give companies' users view-only access, so that a company can see its orders and charges but does not have the ability to generate orders.

While there have been described above the principles of the present invention in conjunction with specific systems and methods of operation, it is to be dearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicant hereby reserves the right to formulate new claims to such features and/or combinations of such features during the prosecution of the present application or of any further application derived therefrom.

The invention claimed is:

1. A subscription management and billing system designed for a multi-tiered supply chain, said system comprising a computing cloud, including:
a. At least one processing unit;
b. A networking layer, comprising a communication interface and a security infrastructure, configured to receive data from multiple client systems and environments;
c. A database layer for storing data, including account information, product specifications, rate tables, subscriptions, and one-time transactions;
d. A processing layer configured to perform multiple processing functions, including bill rating, bill processing, and financial and market analysis;
and configured to perform at least the following functions:
e. Creation of multiple account types associated in a hierarchical structure in which the “parent” entity controls the features available to the “child” entity;
f. Management of buyer accounts that include one or more types of recurring charges and one-time charges;
g. Creation, storage, and use of multiple pricing structures (rate tables) for each product and each entity in the system;
h. Dynamic and instantaneous creation of new rate tables that can be associated with a particular buyer or group of buyers;
i. Immediate use of new or stored rate tables to generate price quotes;
j. Conversion of quotes to orders;
k. Creation, on a periodic basis, of one charge line item for each product/buyer combination that represents the price of that product to that buyer for the given period; and
l. Creation, on a periodic basis, of at least one type of statement, invoice, or other form of aggregate charge information to be used for billing purposes.

2. The system of claim 1, wherein the supply chain consists of buyers and sellers of cloud computing products and services, including at least one vendor, at least one distributor, at least one reseller, and at least one end customer.

3. The system of claim 2, wherein the computing cloud is further configured to accommodate two or more tiers of resellers.

4. The system of claim 1, wherein the computing cloud is configured for sales of multiple cloud products and services from multiple vendors.

5. The system of claim 1, wherein the computing cloud is further configured to define a default rate table for each product/buyer-type combination.

6. The system of claim 1, wherein the computing cloud is further configured so that discounts and promotions may be applied to recurring or nonrecurring transactions through the use of rate tables.

7. The system of claim 1, wherein the computing cloud is further configured to accommodate rate tables with volume-based, tiered, flat-fee, usage-based, and overage pricing.

8. The system of claim 1, wherein the computing cloud is further configured so that rate tables may be used to calculate commission-based compensation.

9. The system of claim 1, wherein the computing cloud is further configured to track a customer's consumption of a usage-based subscription resource and use this information for billing purposes.

10. The system of claim 9, wherein the computing cloud is further configured to calculate and generate charge objects for overages based on a customer's consumption of a resource beyond a defined quantity.

11. The system of claim 1, wherein the computing cloud is further configured such that an order triggers provisioning of the ordered product or service through an application programming interface (API) to the vendor.

12. The system of claim 1, wherein the computing cloud is further configured such that an order triggers a notice to the seller that an order has been placed and requires the seller's approval before the order becomes final.

13. The system of claim 1, wherein the computing cloud is further configured such that the distributor defines and displays for resellers a catalogue of products and services available for ordering and provisioning through the system.

14. The system of claim 13, wherein the computing cloud is further configured such that the distributor may control which catalogue products and services are available to each reseller based on criteria such as whether the reseller has obtained vendor-required certifications.

15. The system of claim 13, wherein the computing cloud is further configured to allow a reseller to define its own catalogue of products and services by selecting from the items made available by the distributor.

16. The system of claim 15, where the computing cloud is further configured to allow a reseller to further customize its catalogue of products and services by adding items not offered for sale by the distributor.

17. The system of claim 1, wherein the computing cloud is further configured to include hierarchical administrative features such that an upstream or “parent” entity establishes the privileges of a downstream or “child” entity and selects the features to which the downstream entity will have access.

18. The system of claim 17, wherein the computing cloud is further configured to include optional limited administrative controls for end customer administrators.

19. The system of claim 17, wherein the computing cloud is further configured to include administrative controls that make optional end-user features available on a customer-by-customer basis.

20. The system of claim 1, wherein the computing cloud is configured to generate one statement or invoice per billing period to each reseller, reflecting the aggregate charges for all services the reseller purchased on behalf of its end customer during the billing period.

21. The system of claim 1, wherein the computing cloud is configured to collect payments on a periodic basis by automatically charging a buyer's credit card using the seller's merchant account.

22. The system of claim 1, wherein the computing cloud is further configured to include an optional feature whereby a reseller may opt to have the distributor bill the reseller's end customer on the reseller's behalf.

23. The system of claim 1, wherein the computing cloud is further configured to include a financial analysis process that draws information from the system databases in order to provide real-time financial analysis, such as profit margin calculations, discounts from previous prices, average price and profit margin across a seller's customer base for a given product, and average margin across all sellers on a particular tier of the supply chain or throughout the supply chain.

24. The system of claim 1, wherein the computing cloud is further configured to include a market metrics process that draws information from the system databases, and optionally from outside sources, to provide real-time market metrics.

25. The system of claim 1, wherein the computing cloud is further configured to enable integration with professional services automation tools such that contacts and other customer information can be imported into the billing system.

26. The system of claim 1, wherein the computing cloud is further configured to enable integration with customer relationships management tools such that contacts and other customer information can be imported into the billing system.

27. The system of claim 1, wherein the computing cloud is further configured to enable “single-sign on,” whereby the user interface is configured, through APIs, to enable system users to access vendor web portals through the billing system without entering separate credentials.

28. A subscription management and billing method designed for a multi-tiered supply chain, said system comprising a computing cloud, the computing cloud including:
a. At least one processing unit;
b. A networking layer, comprising a communication interface and a security infrastructure, configured to receive data from multiple client systems and environments;
c. A database layer for storing data, including account information, product specifications, rate tables, subscriptions, and one-time transactions;
d. A processing layer configured to perform multiple processing functions, including bill rating, bill processing, and financial and market analysis;
and wherein the method performs at least the following functions:
e. Creation of multiple account types associated in a hierarchical structure in which the “parent” entity controls the features available to the “child” entity;
f. Management of buyer accounts that include one or more types of recurring charges and one-time charges;
g. Creation, storage, and use of multiple pricing structures (rate tables) for each product and each entity in the system;
h. Dynamic and instantaneous creation of new rate tables that can be associated with a particular buyer or group of buyers;
i. Immediate use of new or stored rate tables to generate price quotes;
j. Conversion of quotes to orders;
k. Creation, on a periodic basis, of one charge line item for each product/buyer combination that represents the price of that product to that buyer for the given period; and
l. Creation, on a periodic basis, of at least one type of statement, invoice, or other form of aggregate charge information to be used for billing purposes.
